(19) United States
(12) Patent Application Publication
(10) Pub. No.: US 2014/0202950 A1
(43) Pub. Date: Jul. 24, 2014

(54) ANODIZED ALUMINUM OXIDE TUBULAR NANO-POROUS MEMBRANE MODULE AND METHOD OF MANUFACTURE THEREOF

(71) Applicant: ASIAN INSTITUTE OF TECHNOLOGY, Klong Neung (TH)

(72) Inventors: Nitin Afzulpurkar, Klong Neung (TH); Ajab Khan Kasi, Quetta (PK)

(73) Assignee: ASIAN INSTITUTE OF TECHNOLOGY, Klong Neung (TH)

(21) Appl. No.: 13/748,211

(22) Filed: Jan. 23, 2013

(51) Int. Cl. B01D 63/06

(52) U.S. Cl. CPC B01D 63/061; B01D 63/06
USPC 210/321.81; 216/53

(57) ABSTRACT

The present invention relates to an anodized aluminum oxide tubular nano-porous membrane array module and method of manufacture thereof. Further the invention relates to a system of such modules. The tubular membrane modules of the present invention can be cascaded to up-scale the surface area of the overall system rather than scaling the surface area of a single tubular membrane. Thus the volume density that is the available surface area for filtration per unit volume of the system is substantially enhanced without compromising on mechanical stability to withstand the pressure differential defines by the end use application.

### FIELD OF INVENTION

The present invention relates to an anodized aluminum oxide tubular nano-porous membrane array module and method of manufacture thereof. Further the invention relates to a system of such modules.

### BACKGROUND OF THE INVENTION

Anodized Aluminum Oxide (AAO) tubular nano-porous membranes find diverse applications including dialysis and filtration. One of the critical attributes of such tubular membranes is to maintain volume density without compromising on mechanical strength, that is the pressure withstanding capacity that is defined by the end use of such membranes. The volume density refers herein to the ratio of available surface area for filtration to the volume of the tubular membrane.

US Patent Application 20060289351 discloses methods to fabricate nanotubes and nanobead arrays by utilizing nanopores in anodic aluminum oxide (AAO) membranes. Nanotubes of bismuth and other low melting point metals with controlled diameters and lengths can be fabricated by sintering AAO coated with appropriate metals at temperatures above theft melting points. Carbon nanotubes may also be readily formed by carbonizing a polymer on the interior walls of the nanopores in AAO membranes. Palladium nanobead arrays which can be used as ultrafast hydrogen sensors are fabricated by coating the flat surface of AAO membranes with controlled pore-wall ratios.

US Patent Application 20050276743 discloses a method for controlled growth of carbon nanotube (CNT) arrays via chemical vapor deposition (CVD) using novel porous anodic aluminum oxide (AAO) templates, which have been seeded with transition metal catalysts. The resulting CNT bundles may be dense and long and can be used for numerous applications. Further, the porous AAO templates and the CNTs grown thereby, can be functionalized and used for separation of chemical species, hydrogen storage, fuel cell electrocatalyst and gas flow membranes, other catalytic applications, and as a bulk structural material

Japanese Patent JP2004292904 discloses PROBLEM TO BE SOLVED: To obtain an anodization alumina membrane having micropores which are regularly arrayed over a wide area. SOLUTION: A template 15 provided with a particulate layer 13′ arrayed with silica particulates 13 having approximately equal grain sizes in a close-packed state, the silica particulates 13 of the template 15 and an aluminum substrate 16 are pressed onto a glass substrate 14 by a hydraulic press or the like. Next, a plurality of dents 17 closely packed and arrayed in correspondence to the array of silica particulate layer 13′ are formed on the surface 16a of the aluminum substrate 16. Next, the aluminum substrate 16 and a cathode are arranged in an electrolyte kept at a constant temperature and the aluminum substrate 16 is anodically oxidized by impressing a voltage between the aluminum substrate 16 and the cathode.

Patent application number: 20100116733 discloses nanoporous oxide ceramic membranes of tubular and hollow fiber shape and method of making the same. The present invention is aimed to fabricate nanoporous anodic oxide ceramic membrane tubes with excellent pore characteristics by anodizing metal tubes located in a cylindrical symmetry with respect to a cathode which itself has a cylindrical symmetry. The membrane tubes may have protruded portions acting as supports and joints. The present invention also deals with stacks and bundles consisted of numbers of the anodic oxide ceramic tubes for filter and dialysis applications

There is limitation to use a single nano-porous tubular membrane to cater the end application. If only one tubular membrane is used then there are issues regarding surface area available for filtration. If in an attempt to enhance this surface area, if tube diameter is increased there is decrease in the mechanical stability of the membrane. That is the pressure withstanding capacity of the tubular membrane substantially reduces. For example, if a tubular membrane area of 1 m² is required with the thickness of say 10 micrometer, then it is impossible to fabricate such a membrane that could withstand the fluid pressure differential due to ineffective mechanical stability of such a single tube. This demands use of shorter length and diameter tubes to enhance the mechanical stability without compromising on the overall surface area of the tubular membrane. Therefore plurality of such tubular membranes needs to be installed in parallel or series to enhance the surface area without compromising on mechanical stability to withstand the pressure differential defines by the end user.

Further, if the tube diameter is increased, it results in substantial reduction in the hydraulic diameter, that is the effective wetting area of the tube. Therefore it is always desirable to use plurality of smaller diameter tubes to enhance the hydraulic diameter and in turn wetting area of the tube for effective filtration.

There is need to develop tubular membrane modules that can be used in series of parallel configuration to up-scale the surface area of the overall system rather than scaling the surface area of a single tubular membrane. Thus the volume density, that is the available surface area for filtration per unit volume of the system is enhanced using such modules.

The challenge is to make such a module comprising plurality of nano-porous AAO tubular membranes in parallel or series with each other using a simple method of manufacture.

The prior art does not report an arrangement of an array of nano-porous AAO tubular membrane connected to a same terminal headers for inlet and outlet of fluid.

### SUMMARY OF THE INVENTION

The main object of the invention is to provide an anodized aluminum oxide tubular nano-porous membrane array module and method of preparation thereof. Further object of the invention is to provide a system of such modules.

Another object of the invention is to provide inlet and outlet (terminal) headers for the plurality of tubular membranes in the array.

Another object of the invention is to enhance hydraulic diameter of the array system.

Another object of the invention is to prepare array of nano-porous AAO tubular membrane using a single substrate.

Another object of the invention is to enhance volume density of the tubular membranes for a defined application without compromising on mechanical strength/stability of the membranes.

Thus in accordance with the invention the array comprises of

inlet header that is provided with one or plurality of openings, outlet header provided with corresponding one or plurality of openings, nano-porous tubular membranes joining each pair of openings from the said inlet header and the said outlet header, support joining the said headers
wherein the said nano-porous tubular membrane is joined/affixed with the said openings of the headers to form array of tubular membranes
wherein the said array is prepared in steps of:
drilling desired diameter holes in Al substrate that is preferably in the form of a block
electro-polishing of the said substrate comprising steps of:
   placing the said substrate in the mixture of perchloric acid and ethanol respectively wherein the ratio in the range of 1:3 to 1:5 by volume wherein purity of ethanol is in the range of 99%-99.9% and that of Perchloric acid is in the range of 69-72%;
Applying potential at a temperature less than 10° C. wherein the potential is in the range of 10 to 20 V;
Applying potential for 3 to 10 min depending on the surface roughness;
first step anodization comprising steps of:
   selecting electrolyte from either of oxalic acid, phosphoric acid, sulfuric acid and malunic acid wherein the concentration of the said acid depends on the pore size;
   using oxalic acidas electrolyte in the range of 0.2M to 0.3M;
   applying a potential in the range of 35 to 45V wherein process time is in the range from 1 h to 6 h;
chemical etching of the anodized aluminum oxide comprising steps of:
etching in chromic acid and phosphoric acid wherein the temperature is in the range of 65-80° C. wherein phosphoric acid is in the range of 6 wt % to 7 wt % and chromic acid is in the range of 2 wt % to 3 wt % wherein purity of Chromic acid is 99% and purity of phosphoric acid is 85%;
second step anodization comprising steps of:
   Repeating the process in the first step anodization wherein hexagonally arranged nanoporous structures are formed with one end blocked with barrier layer wherein process time depends on the membrane thickness, it can range from 1 h to 48 h depending on membrane thickness.
inlet, outlet headers and support attachment using epoxy, PDMS therelike to the said anodized Al substrate to block the drilled holes to prohibit the chemical used for etching from entering the AAO inside the drilled holes
chemical etching of external AAO comprising steps of:
etching in chromic acid and phosphoric acid wherein the temperature is in the range of 65-80° C. wherein phosphoric acid is in the range of 6 wt % to 7 wt % and chromic acid is in the range of 2 wt % to 3 wt % wherein purity of Chromic acid is 99% and purity of phosphoric acid is 85%.
chemical etching of Al substrate using CuCl2 and HCl
wherein the concentration of CuCl2 is in the range of 0.2 to 0.25M and the concentration of HCl is in the rance of 6 to 6.1M HCl, the temperature is in the range of 40 to 45° C.
wherein the process of chemical etching results in removing Al material around the AAO inside the drilled holes resulting in the formation of array of tubular membranes connected with the said inlet and outlet headers.
barrier layer (BL) removal by placing of AAO in 5 wt % to 6 wt % Phosphoric acid for about 35 to 40 min at 31° C. to 32° C.

In one of the aspects of the invention, the header is selected from materials such as plastic, polymer based material and other material as per the end application.

### BRIEF DESCRIPTION OF THE DRAWINGS

Features and advantages of this invention will become apparent in the following detailed description and the preferred embodiments with reference to the accompanying drawings. The embodiments are illustrated by way of example and not by way of limitation in the figures of the accompanying drawings.

FIG. 1 illustrates schematic of the configuration of the tubular nano-porous membrane array module of the present invention

FIG. 2 illustrates schematic of the inlet and/or outlet header

FIGS. 3(a) and (b) illustrates schematic of the Al block with drilled holes

FIG. 4(a) to (c) illustrates schematic of the substrate top view and formation of AAO

FIG. 5 illustrates schematic of the formation of AAO formation

FIG. 6 illustrates schematic of the headers and block

FIG. 7 illustrates schematic of the tubular membrane formation

### DESCRIPTION OF THE INVENTION

In the following description, various embodiments will be disclosed. However, it will be apparent to those skilled in the art that the embodiments may be practiced with only some or shall disclosed subject matter. For purposes of explanation, specific numbers, materials, and/or configuration are set forth in order to provide a thorough understanding of the embodiments. However, it will also be apparent to one skilled in the art that the embodiments may be practiced without one or more of the specific details, or with other approaches, materials, components etc. In other instances, well-known structures, materials, and/or operations are not shown and/or described in detail to avoid obscuring the embodiments. Accordingly, in some instances, features are omitted and/or simplified in order to not obscure the disclosed embodiments. Furthermore, it is understood that the embodiments shown in the Figures are illustrative representation and are not necessarily drawn to scale.

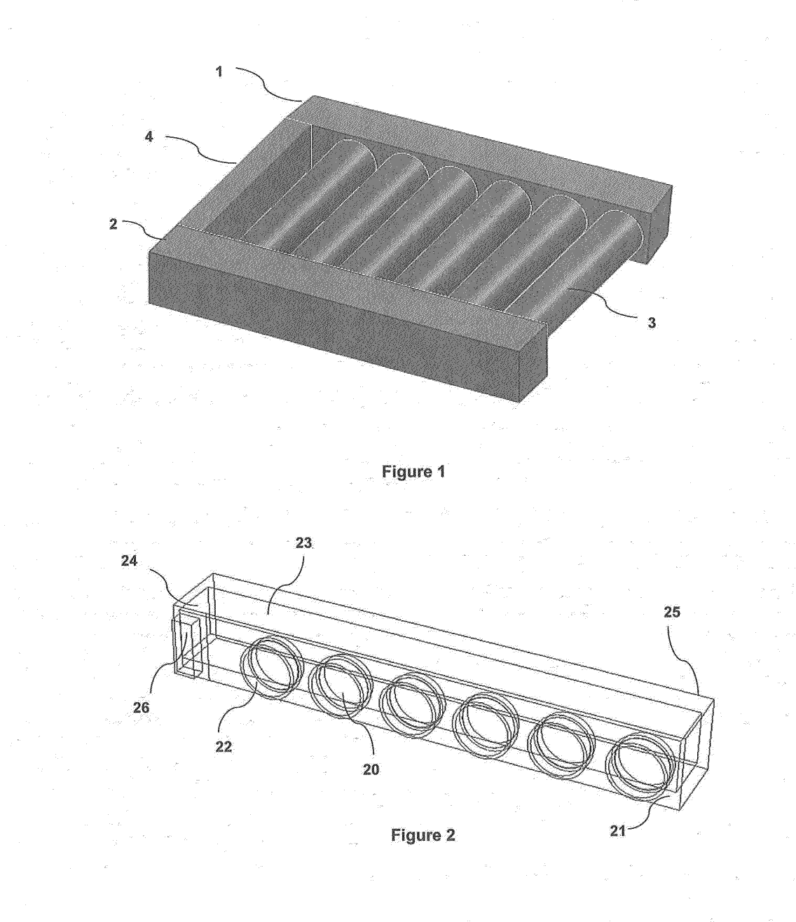

The aluminum oxide tubular nano-porous membrane array module of the present invention is illustrated schematically in FIG. 1. It comprises of the inlet header 1 and the outlet header 2. Plurality of Anodized Aluminum Oxide (AAO) tubular membranes 3 join the said headers as illustrated in the FIG. 1. The support 4 joins the two headers.

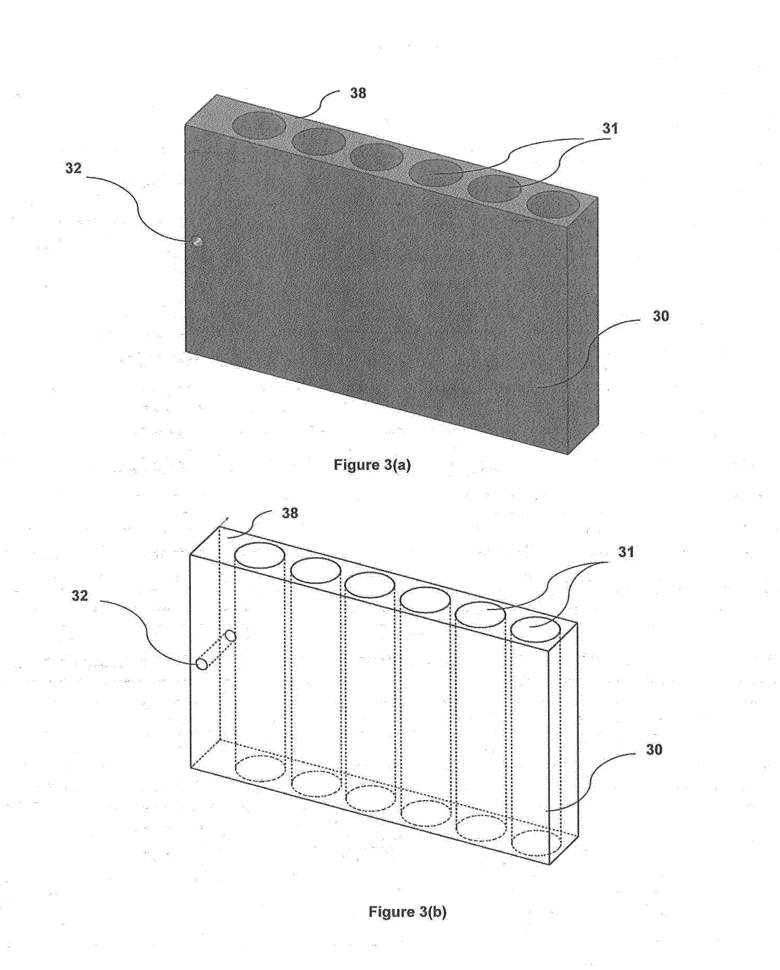

FIG. 2 illustrates details of the inlet and/or outlet header. It comprises of plurality of openings 20 on one of the faces 21 of the rectangular block represented herein as one of the embodiments. In other embodiment the said inlet and outlet headers are selected from circular, rectangular, square, flat oval cross sections. The internal passage 23, 24 is provided inside the body 25 of the header. The said passage 23 is provided with openings 20 from one of the faces 21 of the body 25. The said opening is further provided with a projected circular ring like portion 22 that fits in the nano-porous tubular membrane. The nano-porous tubular membrane and the said projected portion 22 is joined using epoxy, PDMS or therelike. The projected portion 26 is provided at one of the ends of the body 25 to receive the support 4 (refer FIG. 1). In one of the embodiments, the said inlet and outlet headers can be interchanged depending on the flow direction.

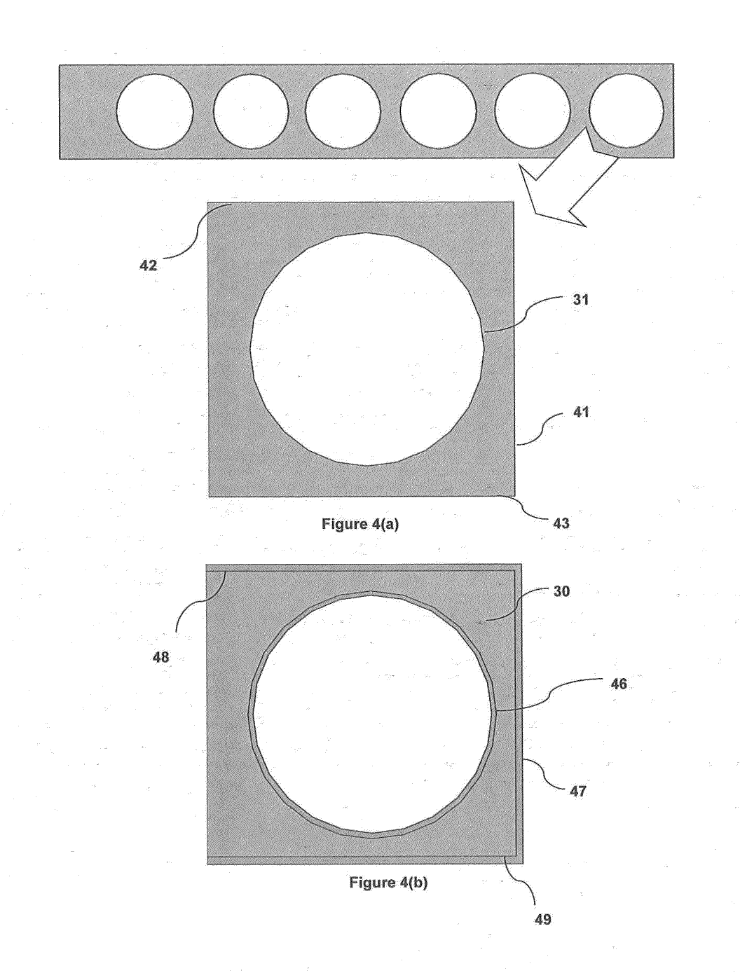

The said array module is prepared in steps of:
drilling desired diameter holes in Al substrate that is preferably in the form of a block. This is illustrated in FIG. 3. The Al substrate in the form of a block 30 is drilled through from one of the surfaces 38 to form plurality of holes 31. The AAO membrane forms in these holes in further process. Attachment 32 is provided in the form of a hole on the said substrate 30 to insert electrode for electro-polishing and anodization process. As illustrated in FIG. 3(b), the holes 31 are drilled through and through the substrate.
Electro-polishing of the said substrate comprising steps of:
   placing the said substrate in the mixture of perchloric acid and ethanol respectively wherein the ratio in the range of 1:3 to 1:5 by volume wherein purity of ethanol is in the range of 99%-99.9% and that of Perchloric acid is in the range of 69-72%;
   Applying potential at a temperature less than 10° C. wherein the potential is in the range of 10 to 20 V;
   Applying potential for 3 to 10 min depending on the surface roughness;
First step anodization comprising steps of:
   selecting electrolyte from either of oxalic acid, phosphoric acid, sulfuric acid and malunic acid wherein the concentration of the said acid depends on the pore size;
   using oxalic acid as electrolyte in the range of 0.2M to 0.3M;
   immersing the said substrate in the said electrolyte;
   applying a potential in the range of 35 to 45V wherein process time is in the range from 1 h to 6 h.

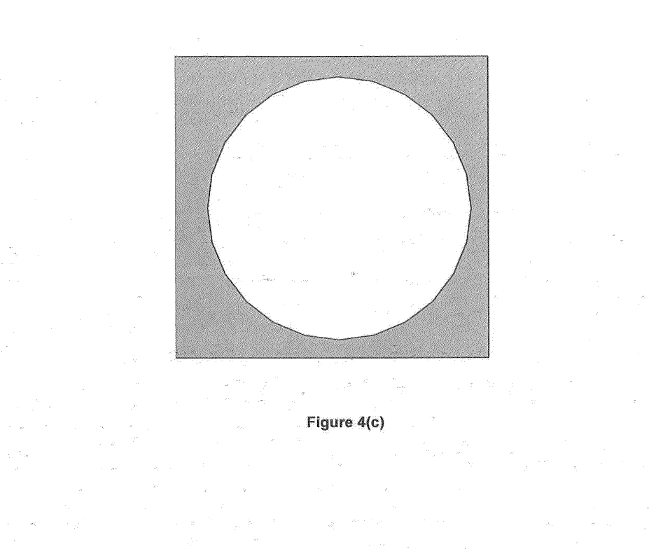

FIG. 4 schematically illustrates the top view of the surface 38 of the said substrate 30 and exploded view of one of the drilled holes 31, the process of first step anodization results in the formation of AAO inside the holes 31. As illustrated in FIG. 4(a). The surfaces 41, 42, 43 and the cylindrical surface of the drilled holes are exposed to this anodization process. FIG. 4(b) illustrates the aspect of formation/growth of AAO as a result of anodization process on the said surfaces. It can be observed that AAO layer 48, 47 and 49 is formed on surfaces 42, 41 and 43 respectively. Further AAO layer 46 is formed in the drilled hole. The Al substrate 30 remains as it is surrounding the said drilled hole 31 as indicated in FIG. 4(b).

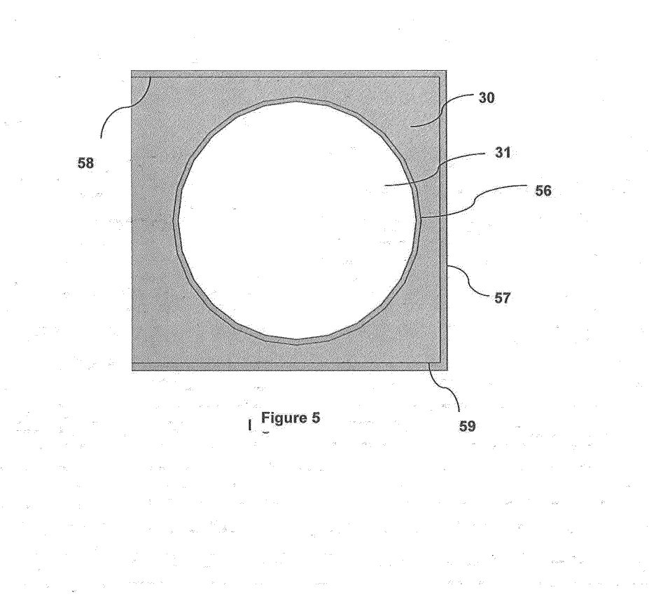

Further chemical etching of the anodized aluminum oxide comprising steps of etching the said substrate in chromic acid and phosphoric acid wherein the temperature is in the range of 65-80° C. wherein phosphoric acid is in the range of 6 wt % to 7 wt % and chromic acid is in the range of 2 wt % to 3 wt % wherein purity of Chromic acid is 99% and purity of phosphoric acid is 85%. As illustrated in FIG. 4c) the said AAO layers (48, 17, 49 and 46) on respective surfaces are etched to expose the said Al substrate 30.
Second step anodization comprising steps of repeating the process in the first step anodization. As schematically illustrated in FIG. 5, hexagonally arranged nanoporous structures 56, 57, 58 and 59 of AAO are formed/grown on each of the surfaces with one end blocked with barrier layer (not shown). The Al substrate 30 surrounds the drilled hole. The process time depends on the membrane thickness; it can range from 1 h to 48 h.

To develop nano-porous tubular membrane, it is important to selectively etch the AAO formed on the external surfaces (57, 58, 59) of the Al substrate as well as Al substrate 30 surrounding the said AAO 56 formed inside the holes 31 and retain the said AAO 56. This is achieved by the innovative synergistic use of the headers that are also used to block the passage of chemical used for etching from entering the said holes 31.

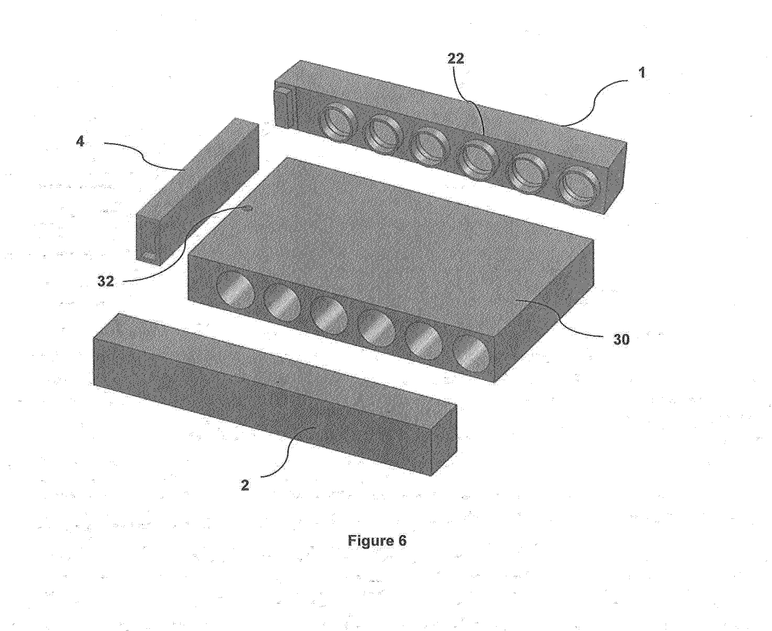

This aspect is illustrated in FIG. 6. The said Al substrate 30 is assembled with the said inlet header 1 and outlet headers 2 respectively wherein support 4 is attached to both the headers as shown in the FIG. 6. The said headers are attached with the said Al substrate corresponding to the ring like projected portion 22 and the drilled holes 30 using epoxy, PDMS etc. The assembly of the said headers 1 and 2 prohibit the chemical used for etching from entering the AAO inside the drilled holes.

The chemical etching of external AAO (57, 58, 59) is carried out comprising steps of: etching in chromic acid and phosphoric acid wherein the temperature is in the range of 65-80° C. wherein phosphoric acid is in the range of 6 wt % to 7 wt % and chromic acid is in the range of 2 wt % to 3 wt % wherein purity of Chromic acid is 99% and purity of phosphoric acid is 85%.

The chemical etching of Al substrate using CuCl2 and HCl is carried out. The concentration of CuCl2 used is in the range of 0.2 to 0.25 M and the concentration of HCl used is in the range of 6 to 6.1M. The temperature is in the range of 40 to 45° C.

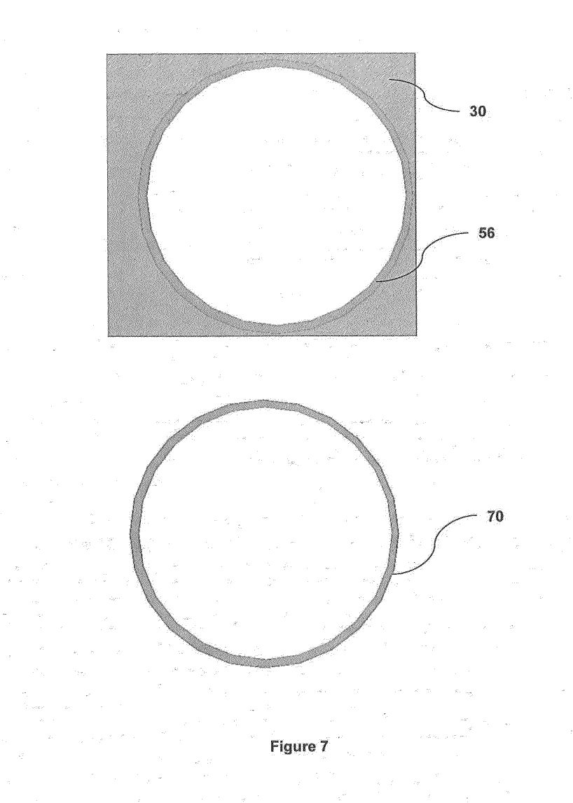

This chemical etching result in the removal of the Al material of the said Al substrate 30 around the AAO 56 (as illustrated in FIG. 7) inside the drilled holes resulting in the formation of nano-porous tubular membrane 70 (top view is shown). Plurality of such tubular membranes is connected with the said inlet and outlet headers (as depicted in the FIG. 1). This membrane has barrier layer which is removed in the further process.

The barrier layer (BL) removal comprises steps of placing of AAO in 5 wt % to 6 wt % Phosphoric acid for about 35 to 40 min at 31° C. to 32° C. for etching of BL.

In one of the embodiments of the invention, the header is selected from materials such as plastic, polymer based material and other material as per the end application.

In another embodiment of the invention, plurality of the said array modules is operably connected in series and/or parallel combination.

We claim:

1. An anodized aluminum oxide tubular nano-porous membrane array module comprising
inlet header that is provided with one or plurality of openings, outlet header provided with corresponding one or plurality of openings, nano-porous tubular membranes joining each pair of openings from the said inlet header and the said outlet header, support joining the said headers
wherein the said nano-porous tubular membrane is joined with the said openings of the headers to form an array of tubular membranes.

2. An anodized aluminum oxide tubular nano-porous membrane array module as claimed in claim 1 wherein the said inlet and/or outlet header comprises of plurality of openings (20) on one of the faces (21);
internal passage (23, 24) provided in the header wherein the said passage is provided with opening/s (20) from one of the faces (21) of the said header;
a projected circular portion (22) provided on the said opening/s that fits in the nano-porous tubular membrane;
wherein the nano-porous tubular membrane and the said projected portion (22) is joined.

3. An anodized aluminum oxide tubular nano-porous membrane array module as claimed in claim 2 wherein the said inlet and/or outlet headers are selected from circular, rectangular, square, flat oval cross sections.

4. An anodized aluminum oxide tubular nano-porous membrane as claimed in claim 1 wherein the said array module is prepared in steps of
(i) drilling desired diameter holes in Al substrate that is preferably in the form of a block;
(ii) electro-polishing the said substrate;
(iii) first step anodization;
(iv) etching of the anodized aluminum oxide;
(v) second step anodization;
(vi) inlet, outlet headers and support attachment to the said anodized Al substrate to block the drilled holes to prohibit the chemical used for etching from entering the AAO inside the drilled holes;
(vii) chemical etching of external AAO;
(viii) chemical etching of Al substrate to remove Al around the AAO inside the drilled holes enabling formation of array of tubular membranes connected with the said inlet and outlet headers;
(ix) barrier layer removal.

5. An anodized aluminum oxide tubular nano-porous membrane as claimed in claim 4 wherein electro-polishing of the said substrate comprises steps of:
(i) placing the said substrate in the mixture of perchloric acid and ethanol respectively wherein the ratio in the range of 1:3 to 1:5 by volume wherein purity of ethanol is in the range of 99%-99.9% and that of Perchloric acid is in the range of 69-72%;
(ii) applying potential at a temperature less than 10° C. wherein the potential is in the range of 10 to 20 V;
(iii) applying potential for 3 to 10 min depending on the surface roughness.

6. An anodized aluminum oxide tubular nano-porous membrane as claimed in claim 4 wherein first step anodization comprises steps of:
(i) selecting electrolyte from either of oxalic acid, phosphoric acid, sulfuric acid and malunic acid wherein the concentration of the said acid depends on the pore size;
(ii) using oxalic acids electrolyte in the range of 0.2M to 0.3M;
(iii) applying a potential in the range of 35 to 45V wherein process time is in the range from 1 h to 6 h.

7. An anodized aluminum oxide tubular nano-porous membrane as claimed in claim 4 wherein chemical etching of the anodized aluminum oxide comprises steps of:
etching in chromic acid and phosphoric acid wherein the temperature is in the range of 65-80° C. wherein phosphoric acid is in the range of 6 wt % to 7 wt % and chromic acid is in the range of 2 wt % to 3 wt % wherein purity of chromic acid is 99% and purity of phosphoric acid is 85%.

8. An anodized aluminum oxide tubular nano-porous membrane as claimed in claim 4 wherein second step anodization comprising steps of:
(i) selecting electrolyte from either of oxalic acid, phosphoric acid, sulfuric acid and malunic acid wherein the concentration of the said acid depends on the pore size;
(ii) using oxalic acids electrolyte in the range of 0.2M to 0.3M;
(iii) applying a potential in the range of 35 to 45V wherein process time is in the range from 1 h to 6 h
to form hexagonally arranged nanoporous structures with one end blocked with barrier layer wherein process time depends on the membrane thickness, it ranges from 1 h to 48 h depending on membrane thickness.

9. An anodized aluminum oxide tubular nano-porous membrane as claimed in claim 4 wherein inlet, outlet headers and support are attached using epoxy, PDMS therelike to the anodized Al substrate.

10. An anodized aluminum oxide tubular nano-porous membrane as claimed in claim 4 wherein chemical etching of external AAO comprising steps of:
etching in chromic acid and phosphoric acid wherein the temperature is in the range of 65-80° C. wherein phosphoric acid is in the range of 6 wt % to 7 wt % and chromic acid is in the range of 2 wt % to 3 wt % wherein purity of chromic acid is 99% and purity of phosphoric acid is 85%.

11. An anodized aluminum oxide tubular nano-porous membrane as claimed in claim 4 wherein chemical etching of Al substrate comprises steps of
etching in CuCl2 and HCl wherein the concentration of CuCl2 is in the range of 0.2 to 0.25M and the concentration of HCl is in the rance of 6 to 6.1M HCl, the temperature is in the range of 40 to 45° C.
wherein the process of chemical etching results in removing Al material around the AAO inside the drilled holes resulting in the formation of array of tubular membranes connected with the said inlet and outlet headers.

12. An anodized aluminum oxide tubular nano-porous membrane as claimed in claim 4 wherein barrier layer is removed by placing of AAO in 5 wt % to 6 wt % phosphoric acid for about 35 to 40 min at 31° C. to 32° C.

13. An anodized aluminum oxide tubular nano-porous membrane as claimed in claim 1 wherein AAO formed on the external surfaces (57, 58, 59) of the Al substrate and the Al substrate (30) surrounding the said AAO (56) formed inside the said drilled holes (31) is selectively etched to retain the said AAO (56) inside the said drilled hole (31)
wherein the said headers (1 and 2) assembled together prohibit the chemical used for etching from entering the AAO inside the said drilled holes.

14. An anodized aluminum oxide tubular nano-porous membrane as claimed in claim 1 wherein plurality of the said array modules are operably connected in series and/or parallel combination.
